(19) United States
(12) Patent Application Publication
(10) Pub. No.: US 2023/0272864 A1
(43) Pub. Date: Aug. 31, 2023

(54) FORMED ARTICLE AND METHOD FOR PRODUCING SAME, AND DIAPHRAGM AND DIAPHRAGM VALVE

(71) Applicant: DAIKIN INDUSTRIES, LTD., Osaka (JP)

(72) Inventors: Hitoshi Imamura, Osaka (JP); Tatsuya Funaoka, Osaka (JP)

(73) Assignee: DAIKIN INDUSTRIES, LTD., Osaka (JP)

(21) Appl. No.: 18/297,305

(22) Filed: Apr. 7, 2023

Related U.S. Application Data
(63) Continuation of application No. PCT/JP2021/036815, filed on Oct. 5, 2021.

(30) Foreign Application Priority Data
Oct. 8, 2020 (JP) 2020-170507

(51) Int. Cl. F16K 7/14; C08L 27/18; C08J 3/28

(52) U.S. Cl. CPC F16K 7/14; C08L 27/18; C08J 3/28; C08J 2327/18

(57) ABSTRACT

Provided is a formed article containing a modified polytetrafluoroethylene, wherein the modified polytetrafluoroethylene contains tetrafluoroethylene unit and a modifying monomer unit based on a modifying monomer copolymerizable with tetrafluoroethylene, wherein a content of the modifying monomer unit in the modified polytetrafluoroethylene is 0.001 to 1% by mass based on the total amount of tetrafluoroethylene unit and the modifying monomer unit, and wherein the formed article has a thickness of 100 μm or more, and is provided by irradiation with radiation having an acceleration voltage of 30 to 300 kV.

### CROSS-REFERENCE TO RELATED APPLICATIONS

This application is a Rule 53(b) Continuation of International Application No. PCT/JP2021/036815 filed Oct. 5, 2021, which claims priority based on Japanese Patent Application No. 2020-170507 filed Oct. 8, 2020, the respective disclosures of which are incorporated herein by reference in their entirety.

### TECHNICAL FIELD

The present disclosure relates to a formed article and a method for producing the same, and a diaphragm and a diaphragm valve.

### BACKGROUND ART

Patent Document 1 discloses a single-layer fluororesin film containing a fluororesin as a main component, wherein irradiation with ionizing radiation from one surface side or both surface sides causes the crosslink density of the fluororesin to gradually decrease with respect to the thickness direction from the surface side irradiated with the ionizing radiation. The amount of the ionizing radiation absorbed in the region in which the distance from the surface irradiated with the ionizing radiation is 5% or less of the average thickness is 150 kGy or more.

In addition, Patent Document 1 discloses a method for producing a fluororesin film, the method including irradiating a single-layer fluororesin film containing a fluororesin as a main component with ionizing radiation under a low oxygen concentration and a molten state of the fluororesin, wherein the fluororesin film is irradiated with the ionizing radiation in such a way that the crosslink density of the fluororesin gradually decreases with respect to the thickness direction from the surface side irradiated with the ionizing radiation.

### CITATION LIST

### Patent Documents

Patent Document 1: Japanese Patent Laid-Open No. 2017-14468

### SUMMARY

The present disclosure provides a formed article containing a modified polytetrafluoroethylene, wherein the modified polytetrafluoroethylene contains tetrafluoroethylene unit and a modifying monomer unit based on a modifying monomer copolymerizable with tetrafluoroethylene, wherein a content of the modifying monomer unit in the modified polytetrafluoroethylene is 0.001 to 1% by mass based on the total amount of tetrafluoroethylene unit and the modifying monomer unit, and wherein the formed article has a thickness of 100 μm or more, and is provided by irradiation with radiation having an acceleration voltage of 30 to 300 kV.

### Effects

The present disclosure can provide a formed article having not only excellent bending resistance but excellent abrasion resistance.

### BRIEF DESCRIPTION OF DRAWINGS

FIG. 1 is a cross-sectional view showing one embodiment of a diaphragm and a diaphragm valve.

FIG. 2 is a schematic diagram for describing a method of an abrasion test.

### DESCRIPTION OF EMBODIMENTS

Hereinafter, specific embodiments of the present disclosure will be described in detail, but the present disclosure is not limited to the following embodiments.

In semiconductor production plants, diaphragm valves are used to supply highly corrosive chemicals and other materials which are used in semiconductor production. Polytetrafluoroethylene (PTFE) and tetrafluoroethylene/perfluoroalkyl vinyl ether copolymers (PFAs) have excellent chemical resistance, non-stickiness, and the like, and therefore are utilized as constituent materials of diaphragm valves. However, particles are generated from the diaphragm valves to cause problems that, for example, the particles lower the yield in semiconductor production.

The present inventors have come up with the idea of irradiating a diaphragm which is used for a diaphragm valve with radiation to improve the abrasion resistance of the diaphragm and suppress the generation of particles from the diaphragm valve. However, it has now been found that in a diaphragm irradiated with radiation according to conventional techniques, the abrasion resistance is improved, but the bending resistance is significantly lowered and the life of the diaphragm is significantly reduced.

Thus, the present inventors have conducted diligent studies to find that by selecting a modified polytetrafluoroethylene as a constituent material for a diaphragm, properly adjusting the thickness of a formed article, and irradiating the formed article of the modified polytetrafluoroethylene whose thickness has been properly adjusted with radiation having an acceleration voltage within an extremely limited range, both of excellent abrasion resistance and excellent bending resistance may be successfully achieved. The formed article of the present disclosure has been completed based on this finding.

The formed article of the present disclosure contains a modified polytetrafluoroethylene (modified PTFE).

The modified PTFE contains tetrafluoroethylene (TFE) unit and a modifying monomer unit based on a modifying monomer copolymerizable with TFE. By using the modified PTFE, a modifying effect due to the irradiation with the radiation under an extremely limited condition is sufficiently exhibited, so that both of the excellent abrasion resistance and the excellent bending resistance may be achieved. In addition, the modified PTFE has an advantage of having excellent creep resistance as compared to homo PTFE consisting of TFE unit and therefore is suitable as a material that forms a diaphragm.

The content of the modifying monomer unit in the modified PTFE is 0.001 to 1% by mass, preferably 0.01% by mass or more, more preferably 0.02% by mass or more, still more preferably 0.03% by mass or more, and particularly preferably 0.04% by mass or more, and is preferably 0.40% by mass or less, more preferably 0.20% by mass or less, particularly preferably 0.10% by mass or less, and most preferably 0.08% by mass or less, based on the total amount of TFE unit and the modifying monomer unit. When the content of the modifying monomer unit is too small, there is a risk of being inferior in abrasion resistance, and when the content of the modifying monomer unit is too large, there is a risk of being inferior in bending resistance.

In the present disclosure, the modifying monomer unit means a part of the molecular structure of the modified PTFE, the part derived from the modifying monomer. The content of the modifying monomer unit may be determined by Fourier transform infrared spectroscopy (FT-IR) described in International Publication No. WO 93/016126.

The modified PTFE is non melt-processible. Being non melt-processible means a characteristic such that a melt flow rate cannot be measured in accordance with ASTM D-1238 and D-2116 at a temperature higher than the crystal melting point.

The modified PTFE preferably has a standard specific gravity [SSG] of 2.13 to 2.23, more preferably 2.13 to 2.19. The SSG is SSG specified in ASTM D4895-89 as an index of the molecular weight of non melt-processible PTFE.

The modified PTFE preferably has a primary melting point of 332 to 348° C. The primary melting point is a value measured setting the temperature-increasing rate in differential scanning calorimetry (DSC) to 10° C./min for the modified PTFE that has no history of being heated to a temperature equal to or higher than 300° C.

The modified PTFE preferably has a secondary melting point of 320 to 329° C., more preferably 321 to 325° C. The secondary melting point is a value measured setting the temperature-increasing rate in differential scanning calorimetry (DSC) to 10° C./min for PTFE heated to a temperature (for example, 360° C.) equal to or higher than the primary melting point.

The modifying monomer is not limited as long as it is copolymerizable with TFE, and examples thereof include perfluoroolefins, such as hexafluoropropylene [HFP]; chlorofluoroolefins, such as chlorotrifluoroethylene [CTFE]; hydrogen-containing fluoroolefins, such as trifluoroethylene and vinylidene fluoride [VDF]; perfluorovinyl ether; perfluoroalkyl ethylene; and ethylene. In some embodiments, a single modifying monomer is used, or a plurality of modifying monomers are used.

The perfluorovinyl ether is not limited, and examples thereof include an unsaturated perfluoro compound represented by the following formula (1).

CF₂═CF—ORf (1)

wherein Rf represents a perfluoro organic group. In the present disclosure, the “perfluoro organic group” means an organic group obtained by substituting each hydrogen atom bonded to a carbon atom with a fluorine atom. In some embodiments, the perfluoro organic group has ether oxygen.

Examples of the perfluorovinyl ether include a perfluoro(alkyl vinyl ether) [PAVE] in which Rf in the formula (1) represents a perfluoroalkyl group having a carbon number of 1 to 10. The perfluoroalkyl group preferably has a carbon number of 1 to 5.

Examples of the perfluoroalkyl group in PAVE include a perfluoromethyl group, a perfluoroethyl group, a perfluoropropyl group, a perfluorobutyl group, a perfluoropentyl group, and a perfluorohexyl group, but perfluoro(propyl vinyl ether) [PPVE], in which the perfluoroalkyl group is a perfluoropropyl group, is preferable.

Examples of the perfluorovinyl ether further include a compound in which Rf in the formula (1) is a perfluoro(alkoxyalkyl) group having a carbon number of 4 to 9, a compound in which Rf in the formula (1) is a group represented by the following formula:

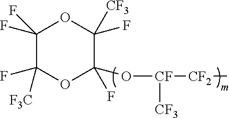

wherein m represents an integer of 0 or 1 to 4, and a compound in which Rf in the formula (1) is a group represented by the following formula:

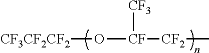

wherein n represents an integer of 1 to 4.

The perfluoroalkyl ethylene is not limited, and examples thereof include (perfluorobutyl)ethylene (PFBE) and (perfluorohexyl)ethylene.

The modifying monomer in the modified PTFE is preferably at least one selected from the group consisting of HFP, CTFE, VDF, PAVE, PFBE, and ethylene. The modifying monomer is more preferably PAVE, still more preferably PPVE.

The formed article of the present disclosure has a thickness of 100 μm or more. When the formed article of the present disclosure has such a thickness, thereby both of the abrasion resistance and the bending resistance may be achieved at a high level. The thickness of the formed article is preferably 130 μm or more, more preferably 160 μm or more, still more preferably 170 μm or more, yet still more preferably 180 μm or more, particularly preferably 190 μm or more, and most preferably 200 μm or more, and is preferably 2.0 mm or less, more preferably 1.0 mm or less, still more preferably 900 μm or less, particularly preferably 800 μm or less, and most preferably 700 μm or less.

The formed article of the present disclosure has a thickness in the above-described range and is provided by irradiation with radiation having an acceleration voltage of 30 to 300 kV. That is, the formed article of the present disclosure may suitably be produced by a production method including forming a modified polytetrafluoroethylene to provide a formed article having a thickness of 100 μm or more, and irradiating the formed article with radiation having an acceleration voltage of 30 to 300 kV to provide a formed article irradiated with the radiation. In providing the formed article, the formed article preferably has a thickness of 130 μm or more, more preferably 160 μm or more, still more preferably 170 μm or more, yet still more preferably 180 μm or more, particularly preferably 190 μm or more, and most preferably 200 μm or more, and is preferably 2.0 mm or less, more preferably 1.0 mm or less, still more preferably 900 μm or less, particularly preferably 800 μm or less, and most preferably 700 μm or less.

The acceleration voltage of the radiation is 30 to 300 kV, and is, because of making it possible to further improve the abrasion resistance while retaining excellent bending resistance, preferably 50 kV or more, preferably 200 kV or less, more preferably 100 kV or less, and still more preferably 80 kV or less.

Because of making it possible to further improve the abrasion resistance without impairing the smoothness of the front side of the formed article while retaining excellent bending resistance, the irradiation dose of the radiation is preferably 30 to 110 kGy, more preferably 40 kGy or more, and more preferably 100 kGy or less.

Because of making it possible to further improve the abrasion resistance without impairing the smoothness of the front side of the formed article while retaining excellent bending resistance, the temperature during irradiation with the radiation is preferably 270 to 310° C., more preferably 280° C. or higher, more preferably 300° C. or lower, and still more preferably 290° C. or lower. In addition, by setting the temperature during irradiation with the radiation within the range, the deformation of the formed article may be prevented.

Adjustment of the temperature during the irradiation is not limited and may be performed by a known method. Specific examples thereof include a method in which the formed article is kept in a heating furnace whose temperature is kept at a predetermined temperature, and a method in which the formed article is put on a hot plate and the hot plate is heated by energizing a heater incorporated in the hot plate or by external heating means.

Only a part of the formed article may also be irradiated with the radiation. When the formed article has a diaphragm shape, only the contact part with a valve seat may be irradiated with the radiation.

Examples of the radiation include an electron beam, an ultraviolet ray, a γ-ray, an X-ray, a neutron beam, or a high-energy ion. Among these, an electron beam is preferable in that it has excellent permeability and a high dosage rate, and is suitable for industrial production.

The irradiation method with the radiation is not limited, and examples thereof include a method which is conducted using a known radiation irradiation apparatus.

The environment in the irradiation with the radiation is not limited, but the oxygen concentration is preferably 1,000 ppm or less, and the environment is more preferably in the absence of oxygen, still more preferably in vacuum or in an atmosphere of an inert gas, such as nitrogen, helium, or argon.

By the irradiation with the radiation under the above irradiation conditions, only a certain depth region of the formed article is suitably modified. In the formed article irradiated with the radiation, the depth of the region modified from the front side is preferably 30% or less, more preferably 20% or less, still more preferably 10% or less, particularly preferably 5% or less, with respect to the thickness of the formed article in the direction of the irradiation with the radiation, and the lower limit is not limited, but is, in some embodiments, 1% or more. By adjusting the depth of the region modified from the front side within the above range, the abrasion resistance may further be improved while the excellent bending resistance of the formed article is retained.

The method for forming the modified PTFE in order to provide the formed article to be irradiated with the radiation is not limited, and a known method may be adopted. Examples of the forming method include a compression forming method, a ram extrusion forming method, and an isostatic forming method. Examples thereof also include a method in which an aqueous dispersion of a modified PTFE is applied and then subjected to drying and sintering, but a formed article such as a diaphragm in which bending resistance is required is difficult to produce by the method, and therefore the method is not preferable in the present disclosure.

The forming method is preferably a compression forming method among others. When a compression forming method is used, a formed article having a desired shape may be provided by filling a metal mold with a powder of the modified PTFE and performing compression to provide a preform and then heating the resultant preform to a temperature equal to or higher than the primary melting point of the modified PTFE.

The shape of the formed article is not limited, and examples thereof include a film, a sheet, a plate, a rod, a block, a cylinder, a container, a tube, bellows, packing, and a gasket. In some embodiments, the formed article is a formed article (also referred to as block) provided by a compression forming method. In addition, forming into a diaphragm shape may provide a formed article having a diaphragm shape.

Further, in some embodiments, after the formed article is provided, the resultant formed article is processed into a desired shape by machining. The modified PTFE has an extremely high melt viscosity even when heated to a melting point or above, making it difficult to perform forming by an extrusion forming method and an injection molding method, which are used for ordinary forming of thermoplastic resins. Accordingly, it is not easy to directly provide a formed article having a complicated and fine shape, such as a diaphragm, from a powder of the modified PTFE. However, by subjecting a formed article formed in advance to machining, even a formed article having a complicated and fine shape may easily be provided.

Examples of the machining method include cutting. For example, a block of the modified PTFE is provided, and then a film is cut out from the provided block by cutting, followed by further processing the provided film by cutting, and thus a formed article having a desired shape can be provided.

The formed article having a desired shape may also be provided by processing the formed article irradiated with the radiation by machining. However, even when the above-described irradiation conditions are applied to a formed article having a small thickness or a formed article having a complicated and fine shape, the shape of the formed article is not impaired, and therefore it is more convenient to process a formed article into a desired shape by machining before irradiation with the radiation.

The formed article of the present disclosure may suitably be used as a diaphragm in particular. The diaphragm of the present disclosure may be used over a long period of time because it is unlikely to be deteriorated even when it comes into contact with a highly corrosive chemical or the like which is used in semiconductor plants and is unlikely to generate particles even when it repeatedly comes into contact with a valve seat, and, on top of these, has excellent bending resistance.

In some embodiments, the diaphragm is one provided by irradiating only a part of it with the radiation and is not limited to one provided by irradiating the whole of it with the radiation.

The diaphragm has a thickness of 100 μm or more. When the diaphragm has such a thickness, thereby both of the abrasion resistance and the bending resistance may be achieved at a high level. The thickness of the diaphragm is preferably 130 μm or more, more preferably 160 μm or more, still more preferably 170 μm or more, yet still more preferably 180 μm or more, particularly preferably 190 μm or more, and most preferably 200 μm or more, and is preferably 2.0 mm or less, more preferably 1.0 mm or less, still more preferably 900 μm or less, particularly preferably 800 μm or less, and most preferably 700 μm or less. In some embodiments, the thickness of the diaphragm is the thickness of the thinnest part of the diaphragm.

A diaphragm valve of the present disclosure includes a valve seat and the above-described diaphragm. The diaphragm valve of the present disclosure may be used over a long period of time because it is unlikely to be deteriorated even when it comes into contact with a highly corrosive chemical or the like which is used in semiconductor plants and is unlikely to generate particles even after repeated opening and closing, and, on top of these, the diaphragm has a long life. The diaphragm valve preferably includes a valve seat installed in the valve main body and the above-described diaphragm that is in contact with or separated from the valve seat.

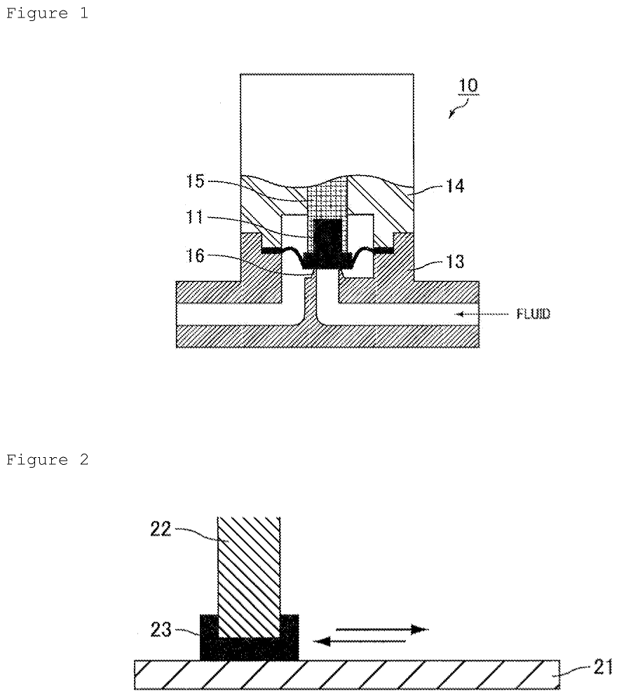

FIG. 1 is a schematic cross-sectional view of one embodiment of the diaphragm and diaphragm valve of the present disclosure. A diaphragm valve 10 shown in FIG. 1 is closed. As shown in FIG. 1, a cylinder 14 is connected to a body (valve main body) 13. In addition, the diaphragm valve 10 includes a diaphragm 11, and the peripheral edge part of the diaphragm 11 is sandwiched between the body 13 and the cylinder 14 and thereby the diaphragm 11 is fixed. Further, a piston rod 15 is connected to the diaphragm 11, and when the piston rod 15 is moved up and down, thereby the diaphragm 11 is also moved up and down.

A valve seat 16 is installed in the body 13, and when the diaphragm 11 comes into contact with the valve seat 16, thereby a fluid flowing in is shielded, and when the diaphragm 11 is separated from the valve seat 16, the fluid is supplied. In this way, the diaphragm valve 10 controls the flow amount of the fluid by coming into contact with and being separated from the valve seat 16. Then, since the diaphragm 11 is a diaphragm having the above-described configuration, particles are unlikely to be generated even when the contact and separation are repeated.

The body 13 having the valve seat 16 integrally formed therein may be composed of a metal, a resin, or the like. Examples of the resin include PTFE, a tetrafluoroethylene/perfluoroalkyl vinyl ether copolymer (PFA), and polyphenylene sulfide (PPS). Among these, PFA is preferable because of easiness of forming and excellent chemical resistance. Particles are unlikely to be generated from the diaphragm of the present disclosure even after the repeated contact with and separation from the valve seat composed of PFA. The PFA is preferably melt-fabricable.

The embodiments have been described above, and it will be understood that various changes in the embodiments and details may be made without departing from the spirit and scope of the claims.

The present disclosure provides a formed article containing a modified polytetrafluoroethylene, wherein the modified polytetrafluoroethylene contains tetrafluoroethylene unit and a modifying monomer unit based on a modifying monomer copolymerizable with tetrafluoroethylene, wherein a content of the modifying monomer unit in the modified polytetrafluoroethylene is 0.001 to 1% by mass based on the total amount of tetrafluoroethylene unit and the modifying monomer unit, and wherein the formed article has a thickness of 100 μm or more, and is provided by irradiation with radiation having an acceleration voltage of 30 to 300 kV.

In the formed article of the present disclosure, the irradiation dose of the radiation is preferably 30 to 110 kGy.

In the formed article of the present disclosure, the temperature during the irradiation with the radiation is preferably 270 to 310° C.

In the formed article of the present disclosure, the modified polytetrafluoroethylene preferably has a secondary melting point of 320 to 329° C.

The formed article of the present disclosure is preferably a diaphragm.

In addition, the present disclosure provides a diaphragm valve including a valve seat and the above diaphragm.

In the diaphragm valve of the present disclosure, the valve seat is preferably composed of a tetrafluoroethylene/perfluoroalkyl vinyl ether copolymer.

Further, the present disclosure provides a production method for producing the above formed article, the method including: forming the modified polytetrafluoroethylene to provide a formed article having a thickness of 100 μm or more; and irradiating the formed article with radiation having an acceleration voltage of 30 to 300 kV to provide a formed article irradiated with the radiation.

### EXAMPLES

Next, the embodiments of the present disclosure will be described with reference to Examples, but the present disclosure is not limited to those Examples.

Numerical values in Examples were measured by the following methods.

(Secondary Melting Point of Modified PTFE)

The secondary melting point of the modified PTFE was determined as a temperature corresponding to a maximum value in a heat-of-fusion curve obtained by increasing temperature at a rate of 10° C./min using a differential scanning calorimeter [DSC].

(Content of Modifying Monomer Unit)

The content of the modifying monomer unit was determined from characteristic absorption (between 1040 cm⁻¹ to 890 cm⁻¹ in the case of perfluoro(propyl vinyl ether) (PPVE)) by infrared spectroscopy.

(Abrasion Test)

The test was conducted using a sheet (test piece) having a thickness of 0.5 mm. A color fastness rubbing tester (manufactured by YASUDA SEIKI SEISAKUSHO, LTD.) was used, and as shown in FIG. 2, a PFA sheet 23 fixed at the head end of a friction block 22 was placed on a sheet (test piece) 21, and both were rubbed back and forth against each other. The load was set to 500 g and the number of cycles was set to 2,000 cycles (30 cycles/min). The front side of the frictionally rubbed sheet (test piece) was visually observed and evaluated according to the following criteria.

2: Scratches were hardly observed on the front side of the sheet (test piece).

1: Some scratches were observed on the front side of the sheet (test piece).

0: Many scratches were observed on the front side of the sheet (test piece).

(MIT Value)

The MIT value was measured in accordance with ASTM D2176. Specifically, a test piece of 12.5 mm wide, 130 mm long, and 0.20 mm thick, the test piece unirradiated or irradiated with an electron beam, was mounted on an MIT tester (Model No. 12176, (manufactured by YASUDA SEIKI SEISAKUSHO, LTD.)) and bent under a condition of a load of 1.25 kg, a left-and-right folding angle of 135 degrees on each side, and a number of cycles of folding of 175 cycles/min, and the number of cycles until the test piece was cut off (MIT value) was measured.

The MIT value was evaluated according to the following criteria.
2: The MIT value is more than 10,000,000 cycles.
1: The MIT value is 5,000,000 to 10,000,000 cycles.
0: The MIT value is less than 5,000,000 cycles.

(Overall Evaluation)

The overall evaluation was conducted from the MIT value and the result of the abrasion test according to the following criteria.

Excellent: The total score of the appearance evaluation and the evaluation of the MIT value is 3 or more.

Poor: The total score of the appearance evaluation and the evaluation of the MIT value is 2 or less.

### Comparative Example 1

A modified PTFE powder (containing 0.06% by mass of PPVE unit based on the total amount of TFE unit and PPVE unit and having a secondary melting point of 323° C.) provided in the same manner as in Example 1 described in International Publication No. WO 93/016126 was used. A metal mold of 50 mmϕ and 50 mm high was filled with 200 g of the powder, and both sides of the metal mold were pressed at a pressure of 15 MPa to keep the pressure for 30 minutes, and thus a preform was provided. This preform was heated at a temperature-increasing rate of 90° C./hour, and thereafter the temperature was kept at 360° C. for 4 hours and then decreased at 40° C./hour to provide a block of a formed article. This block was cut to prepare a sheet having a thickness of 0.20 mm and a sheet having a thickness of 0.5 mm.

A test piece was provided by cutting the sheet having a thickness of 0.5 mm into a width of 30 mm and a length of 220 mm, and the abrasion test was conducted for the formed article using the provided test piece. The MIT value was measured using the sheet having a thickness of 0.20 mm. Table 1 shows the results.

### Study Example 1

The sheet (test piece) having a thickness of 0.5 mm and sheet having a thickness of 0.20 mm which were provided in Comparative Example 1 above were housed in an electron beam irradiation container of an electron beam irradiation apparatus (manufactured by NHV Corporation), and thereafter a nitrogen gas was added to create a nitrogen atmosphere inside the container. The temperature inside the container was increased to 280° C. and stabilized, and thereafter the test piece was irradiated with an electron beam of 40 kGy under a condition in which the acceleration voltage of the electron beam was 3,000 kV and the intensity of the irradiation dose was 20 kGy/5 min. Evaluations were conducted in the same manner as in Comparative Example 1 using a sheet (test piece) provided by irradiation with the electron beam. Table 1 shows the results.

### Study Examples 2 to 9

A sheet (test piece) irradiated with an electron beam was provided in the same manner as in Study Example 1 except that the condition in irradiation with the electron beam was changed as shown in Table 1. Evaluations were conducted in the same manner as in Comparative Example 1 using the provided sheet (test piece). Table 1 shows the results.

### [Table 1]

TABLE 1

| | | | Study | Study | Study | Study | Study | Study | Study | Study | Study |
|---|---|---|---|---|---|---|---|---|---|---|---|
| | | Comparative | Exam- | Exam- | Exam- | Exam- | Exam- | Exam- | Exam- | Exam- | Exam- |
| | | Example 1 | ple1 | ple2 | ple3 | ple4 | ple5 | ple6 | ple7 | ple8 | ple9 |
| Electron beam | kV | Untreated | 3000 | 3000 | 3000 | 300 | 150 | 70 | 70 | 70 | 50 |
| acceleration | | | | | | | | | | | |
| voltage | | | | | | | | | | | |
| Temperature | ° C. | | 280 | 280 | 280 | 280 | 280 | 280 | 280 | 280 | 280 |
| during | | | | | | | | | | | |
| irradiation | | | | | | | | | | | |
| Irradiation | kGy | | 40 | 60 | 100 | 60 | 60 | 40 | 60 | 100 | 60 |
| dose | | | | | | | | | | | |
| Abrasion test | Appearance | 0 | 1 | 2 | 2 | 2 | 2 | 1 | 2 | 2 | 2 |
| | evaluation | | | | | | | | | | |
| MIT value | (10⁴ cycles) | >1000 | (*1) | <500 | <1 | 500-1000 | 500-1000 | >1000 | >1000 | >1000 | >1000 |
| Overall | | Poor | | Poor | Poor | Excellent | Excellent | Excellent | Excellent | Excellent | Excellent |
| evaluation | | | | | | | | | | | |

(*1) Unmeasured

### REFERENCE SIGNS LIST

10 Diaphragm valve
11 Diaphragm
13 Body
14 Cylinder
15 Piston rod
16 Valve seat
21 Sheet (test piece)
22 Friction block
23 PFA sheet

1. A formed article comprising a modified polytetrafluoroethylene,
wherein the modified polytetrafluoroethylene comprises tetrafluoroethylene unit and a modifying monomer unit based on a modifying monomer copolymerizable with tetrafluoroethylene,
wherein a content of the modifying monomer unit in the modified polytetrafluoroethylene is 0.001 to 1% by mass based on the total amount of tetrafluoroethylene unit and the modifying monomer unit, and
wherein the formed article has a thickness of 100 μm or more, and
is provided by irradiation with radiation having an acceleration voltage of 30 to 300 kV.

2. The formed article according to claim 1, wherein an irradiation dose of the radiation is 30 to 110 kGy.

3. The formed article according to claim 1, wherein a temperature during the irradiation with the radiation is 270 to 310° C.

4. The formed article according to claim 1, wherein the modified polytetrafluoroethylene has a secondary melting point of 320 to 329° C.

5. The formed article according to claim 1, wherein the formed article is a diaphragm.

6. A diaphragm valve comprising:
a valve seat; and
the diaphragm according to claim 5.

7. The diaphragm valve according to claim 6, wherein the valve seat is composed of a tetrafluoroethylene/perfluoroalkyl vinyl ether copolymer.

8. A production method for producing the formed article according to claim 1, the method comprising:
forming the modified polytetrafluoroethylene to provide a formed article having a thickness of 100 μm or more; and
irradiating the formed article with radiation having an acceleration voltage of 30 to 300 kV to provide a formed article irradiated with the radiation.
